(19) United States
(12) Patent Application Publication
(10) Pub. No.: US 2004/0208006 A1
(43) Pub. Date: Oct. 21, 2004

(54) Light fitting

(76) Inventor: Enrico Schneider, Basel (CH)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/481,854

(22) PCT Filed: Jun. 20, 2001
(86) PCT No.: PCT/CH01/00387

(51) Int. Cl. F21V 1/00

(52) U.S. Cl. 362/292

(57) ABSTRACT

The illumination body (1) has a housing (2) with a bottom element (3) and a radiation source (5) fixed on the side wall (4). Furthermore, three stationary mirrors (6, 7 and 8) are arranged in the housing (2), which mirrors serve as deflection elements for the radiation and, through reflection, effect a lengthening of the beam path (9) within the illumination body (1). Furthermore, an l-shaped radiation element (11), which can be rotated about a vertical axis (12), is seated in an opening (10) in the bottom element (3). The said radiation element essentially comprises a vertical and a horizontal tube section (13 and 14, respectively) and has, in the transition region between the two sections (13 and 14), a—preferably stationary—deflection mirror (15), which is inclined by 45° and deflects the vertically incident beam path (9) by 90° and directs it onto the directional mirror (16). The latter, for optimum variable space illumination, can be pivoted about a horizontal axis (17), which is perpendicular to the beam path (9) and directs the light, which, if necessary, is additionally oriented in a parallel fashion by means of a converging lens and/or focusing optical arrangement (not shown), through the light exit opening (14a) into the space to be illuminated or onto the stage to be illuminated.

The present invention relates to a novel illumination body for illuminating a space, for example a television studio, or a theatre or concert stage.

The illumination body according to the invention, also called spotlight hereinafter, has a radiation directing system with at least one radiation source which emits a preferably parallel-directed radiation. Furthermore, the spotlight is created in such a way that it can be fitted to a conveyor rail system in order thus to ensure flexible and mobile illumination of the space or of the stage. A conveyor system serving to accommodate the spotlight according to the invention is disclosed for example in WO 99/50122.

The illumination specialists in the entertainment sector make ever greater demands. In other words, the spotlights must cover all requirements of lighting technicians. The entertainment sector demands sophisticated effects which can captivate the audience. Moreover, the film, television and theatre sectors are concerned about rapidity in order, inter alia, to keep the production costs as low as possible.

Known illumination installations for television studios, theatre stages or the like have spotlights which can be fitted to a conveyor rail system arranged on the ceiling and can be manually positioned on the rails. Supply boxes are fitted to the ceiling at regular intervals and a spotlight, once positioned, can be supplied with current and control pulses from the said supply boxes. Another system for an illumination installation provides for the fitting of a multiplicity of vertically adjustable spotlights, those spotlights which are at the appropriate location being used as required. Although these systems enable flexible operation, they nonetheless necessitate major capital expenditure on expensive spotlights and considerably restrict the number of positions from which a spotlight can be used.

Problems that cannot be ignored have arisen on account of the ever rising technical requirements made of illumination installations and spotlights. Thus, in the case of a spotlight moved by its head, the entire housing is moved, and, on account of the weight and a length of up to 0.7 m, this is possible only by means of a complicated suspending and moving apparatus and powerful electric motors. Furthermore, the known spotlights are sluggish in their mobility and can no longer be used appropriately in particular when fast light direction changes are demanded. Added to this is the fact that optimal cooling of the spotlights proves to be very difficult since the horizontal position of the light source changes in the course of pivoting and the said light source thus takes up a position that is often unfavourable for the cooling. In order to eliminate this deficiency, spotlights have indeed been developed which move the light beam by means of a mirror. However, the disadvantage here is that the freedom of movement of these spotlights is greatly circumscribed. These spotlights are principally used in the concert and entertainment sector since they lack important functions for use in theatre or television.

The invention is based on the object, then, of providing a new spotlight or illumination body which does not have the disadvantages of the spotlights described above and can be used in particular as a mobile element in conveyor systems of a known type.

This object is achieved by means of an illumination body having the features of claim 1.

The dependent claims relate to advantageous embodiments of the invention.

It is an essential feature of the invention that the radiation which is supplied by the radiation source and, if appropriate, is directed in a parallel fashion is repeatedly reflected by means of a plurality of mirrors and the beam path is limited to a confined space. The invention makes it possible, in particular, to provide spotlights having a beam path of up to 1.5 m in which a significant part of the beam path is integrated in a space having a diameter of about 50 cm.

The spotlight according to the invention comprises a housing forming the said space, in which housing the light source is fixed in a stationary manner at a suitable location, and a radiation element which is arranged on the housing and can also be rotated about a vertical axis. The said radiation element has, as essential components, a deflection mirror, in order that the beam path which is incident from the housing vertically into the radiation element is directed into a horizontal position, or a position inclined at most by 45°, and also a directional mirror arranged at the end of the beam path. By means of corresponding positioning of the directional mirror by vertical rotation of the radiation element, the radiation which arrives from the deflection mirror and is preferably directed in a parallel fashion can then be directed in a predetermined manner onto different objects, without changing the horizontal position of the light source in the process, for which purpose the directional mirror may additionally be arranged such that it is pivotable, to be precise about a horizontal axis perpendicular to the beam path.

Preferably, in the radiation directing system according to the invention, each mirror may be preceded or succeeded by at least one, if necessary exchangeable, optical element, such as a lens, a diaphragm, a filter, a transparency or the like. With the aid of these additional devices in the form of variable optical elements, the beam which is reflected repeatedly by means of the mirrors can be focused or scattered, and corresponding colour effects can be achieved with the aid of colour filters, or it is also possible to project transparencies in the branched-off beam path at a desired location. These optical elements positioned in the beam path can be chosen freely depending on the respectively desired requirements and conditions.

Instead of, if necessary exchangeable, optical elements the radiation directing system according to the invention may also be equipped with a digital microchip element (digital micromirror device) which allows all conceivable colours and colour combinations and also other effects which are generated in a computer and communicated to the spotlight in digital signal form to be transformed by means of a decoder into an optically projectable form. This technology, which is already known per se from the cinema sector, makes the spot-light according to the invention even simpler in its design and also even more effective with regard to mobility. Moreover, it imparts to the spotlight a virtually inexhaustable multiplicity of different kinds of effect options.

The directional mirror of the radiation element may, of course, also be rotatable about two axes which together form an angle of 90°, thereby enabling the variable space illumination to be optimized further.

For the pivoting or rotation of radiation element and directional mirror, use is preferably made of small servo-motors or the like which, for their part, can be driven by a central control unit which will be referred to in more detail below.

The spotlights according to the invention comprise, for example, a compact housing with a, for example, square base area and a tubular radiation element which is inserted in the said housing in a releasable manner. Both are preferably metallic and provided with the electrical connections that may be necessary for the light source, the movement of the spotlight and/or the control of the pivotable mirrors and the other additional devices. Furthermore, the spotlight is designed in such a way that the housing containing the light source can preferably be mounted in a horizontal position on a conveyor rail system of the type mentioned in the introduction.

The radiation source provided is, for example, a high-power light source, which is formed by an arc lamp, in particular a halogen metal vapour lamp, a halogen sulphur lamp or the like.

Further details, features and advantages of the invention emerge from the following description of preferred embodiments with reference to the accompanying drawing, in which

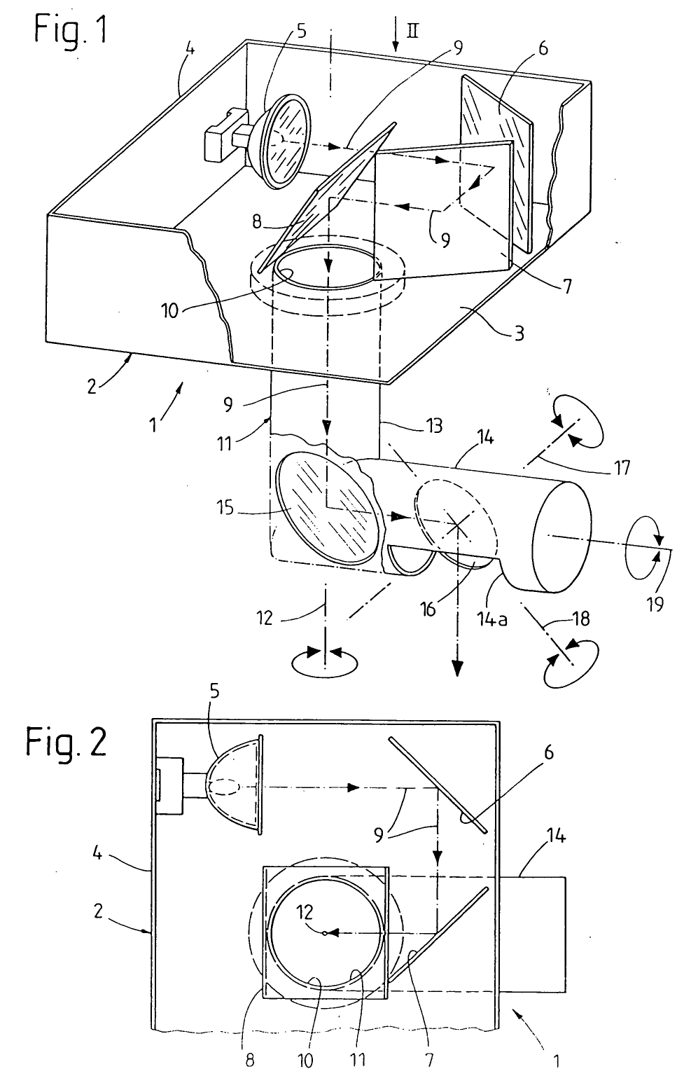

FIG. 1 shows a perspective view of an illumination body according to the invention with an l-shaped radiation element,

FIG. 2 shows a plan view in the direction of the arrow in FIG. 1,

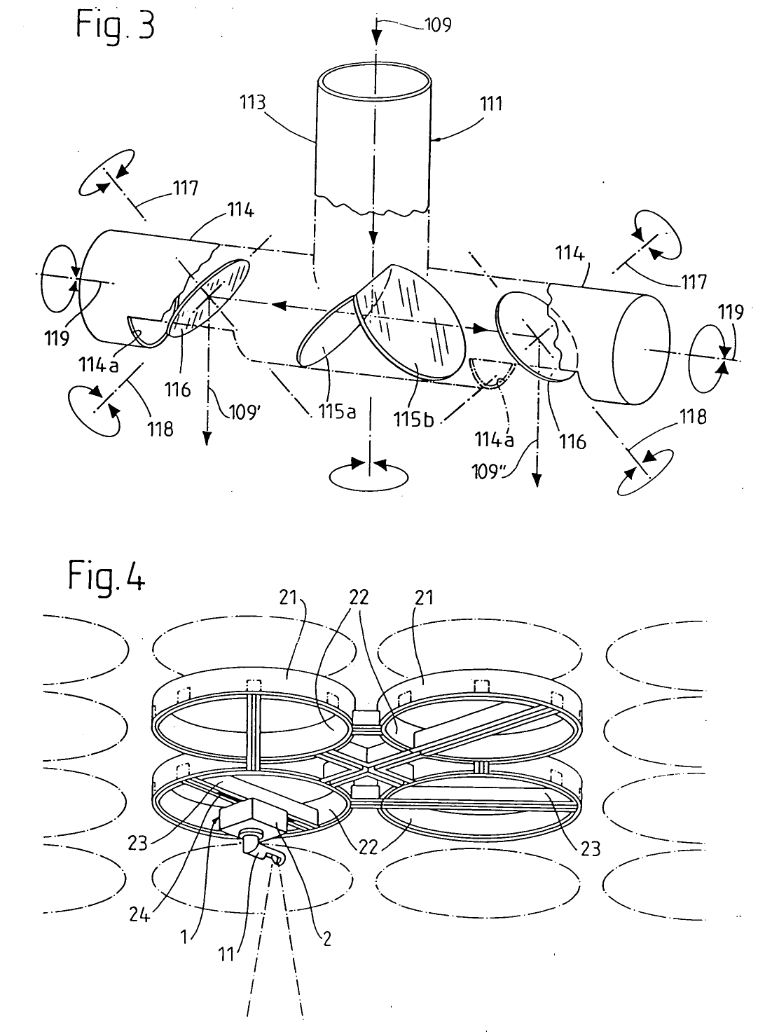

FIG. 3 shows a second embodiment of a radiation element,

FIG. 4 shows a perspective view of part of an illumination installation with a diagrammatically illustrated illumination body in accordance with FIG. 1,

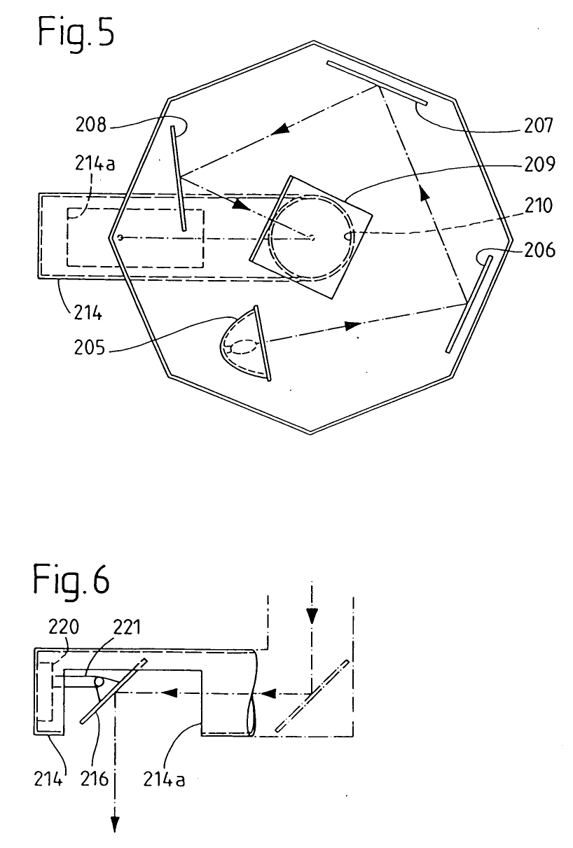

FIG. 5 shows a second embodiment of an illumination body according to the invention with an l-shaped radiation element, and

FIG. 6 shows a diagrammatic illustration of part of the radiation element of FIG. 5.

The illumination body which is illustrated in FIGS. 1 and 2 and is designated in its entirety by 1 has a housing 2, which is square in plan, with a horizontal bottom element 3 and a likewise horizontal cover (not shown). A radiation source 5 is fixed on the side wall 4. Furthermore, three stationary mirrors 6, 7 and 8 are arranged in the housing 2, which mirrors serve as deflection elements for the radiation and, through reflection, effect a lengthening of the beam path 9 within the illumination body 1.

Furthermore, an l-shaped radiation element 11, which can be rotated about a vertical axis 12, is seated in an opening 10 in the bottom element 3. The said radiation element essentially comprises a vertical and a horizontal tube section 13 and 14, respectively and has, in the transition region between the sections 13 and 14, a—preferably stationary—deflection mirror 15, which is inclined by 45° and deflects the vertically incident beam path 9 by 90° and directs it onto the directional mirror 16. The latter, for optimum variable space illumination, can be pivoted about a horizontal axis 17, which is perpendicular to the beam path 9 and directs the light, which, if necessary, is additionally oriented in a parallel fashion by means of a converging lens and/or focusing optical arrangement (not shown), through the light exit opening 14a into the space to be illuminated or onto the stage to be illuminated.

The mirrors 7 and 8, which are perpendicular to the bottom element 3 are arranged at a distance from one another in such a way that they horizontally deflect, once in each case, the light radiation generated by the light source and direct it onto the mirror 9 inclined by 45°. The latter, during operation of the spotlight 1, projects the impinging light beam vertically downwards onto the mirror 15 of the radiation element 11.

The mirror 16 may, if necessary, additionally be pivotable about a second axis 18, which is perpendicular to the horizontal axis 17, and/or the tube section 14 may be pivotable about a horizontal axis 9, with the result that even better variable space illumination is then possible.

The radiation element, which is designated in its entirety by 11, is preferably fixed on the housing 2 in a releasable manner, so that it can readily be replaced by another radiation element, for example by a radiation distributing element. Such an element may, for example, have the form of the element 111 illustrated in FIG. 3. In the case of this essentially t-shaped element, the beam path 109, which is deflected vertically downwards in the tubular section 113, is divided, at the two mirrors 115a and 115b, which are inclined by 45° and also perpendicular to one another, into two horizontal beam paths 109′ and 109″, which are deflected by the directional mirrors 116 in the two tube sections 114—which can be rotated if necessary independently of one another about the horizontal axis 119—and are projected from the light exit opening 114a into the illumination space. In this case, the two mirrors 116 can also be pivoted about a horizontal axis 117 and about a second axis 118 perpendicular thereto, in the same way as has already been described with reference to FIGS. 1 and 2.

As mentioned in the introduction, the illumination body 1 according to the invention is preferably connected to a conveyor rail system in accordance with WO 99/50122. Such a system has a plurality of rotating apparatuses which are coupled to one another via crossover points and each comprise two component parts, namely a pivot bearing, which is designated in its entirety by 21 and is fixedly installed at the crossover points of the conveyor rail system, and a pivotable rail carrier, which is designated in its entirety by 22 and matches the pivot bearing 21.

The pivot bearing 21 essentially comprises a hollow cylinder provided with threaded holes on which fixing means can engage, in order to fit the rotating apparatus to a ceiling or to scaffolding. Depending on the construction of the conveyor rail system, there are fixed to the cylinder, for example, eight rail attachments of stationary conveyor rails, which are guided radially outwards from the cylinder surface.

The rail carrier 22 likewise comprises a hollow cylinder. Its external diameter is a little smaller than the internal diameter of the hollow cylinder associated with the pivot bearing 21, with the result that the rail carrier 22 can be inserted into the associated pivot bearing 21. Arranged in the lower part of the rail carrier 22 is a horizontally pivotable rail section 23 for accommodating a mobile spotlight 1, which, for its part, is supplied with current via contact tracks (not shown) and a trolley 24. In order to feed in current and, depending on that, control signals into the contact tracks of the conveyor rail system, one of the stationarily installed rails is contact-connected via cables which are connected to power supply and, if necessary, control units.

In known illumination systems, the spotlight is provided with means by which its height can be adjusted and by which its light can be projected in any desired direction. In the spotlight 1 according to the invention, the housing 1 containing the light source will only move horizontally and, for optional variable space illumination, only the radiation element 11 will pivot about the vertical axis 12 and the directional mirror 16 contained therein about at least the horizontal axis 17.

The advantages of the spotlight result from its construction. The spotlight is always in the same horizontal position and nevertheless has the entire freedom of movement of a spotlight which is moved by its head. As a result, it is possible to ensure optimum cooling of the spotlight. Moreover, the servomotors, which are now likewise always in the same position and only have to move a small weight, can be designed in a simpler manner. This in turn has a favourable effect on the cooling, the energy consumption and the production costs for the spotlight.

If the spotlight according to the invention is equipped with a digital microchip element (Digital Micromirror Device), it can be used as a fast effect spotlight with a virtually inexhaustable multiplicity of different types of effect options. Even today it is true that a spotlight for generating special effects is equipped with a comparatively large number of mechanical elements and motorized parts which results in a disadvantages increase in weight and size and also disadvantages with regard to the mobility of the spotlight. The use of the abovementioned microchip technology in the spotlight according to the invention allows now only an increase in the possible effects that can be generated, but also a design that is simplified even further and manages without special elements such as colour filters and the like. In this case, then, all that remains of the known optical components are the light source and the lens system in the housing of the spotlight, with the result that, as a further advantage of the spotlight according to the invention, the mechanical wear of optical elements by overheating is also obviated.

The illumination installation in accordance with FIG. 4 also has a central control unit, which is not illustrated in the drawing. With the aid of this control unit the position and present function of each spotlight can be continuously adapted to specific requirements according to a predetermined programme or by direct operation. The driving of the spotlights, of the trolleys and, in particular, of the control means for vertical rotation of the radiation element and pivoting of the directional mirror is then effected either by means of a control signal modulated onto the power supply, by means of additional contact tracks or by means of infrared remote control.

Finally, it shall also be mentioned that the spotlight described above in no way constitutes the only possible embodiment of the invention and can also be changed in many respects. It is thus readily conceivable, for example, to reduce the size of the housing and to crop the corners of the housing, or to provide a housing having a circular base area. A second embodiment of the invention is therefore illustrated in FIGS. 5 and 6. The spotlight shown in these figures has a housing with a light source 205 and also an l-shaped radiation element 214—in the opening 210—of the type described above. The said radiation element is provided with a pivotable directional mirror 216, which can be moved by means of an electrically controllable servomotor 220 and associated articulated joint 221 and directs the light beam through the light exit opening 214a into the space to be illuminated. In contrast to the spotlight 1, this second spotlight has an octagonal base area on which are arranged three perpendicular reflection mirrors 206, 207 and 208 and also a deflection mirror 209—inclined by 45°—for vertical deflection of the light beam into the radiation element 214.

1. Illumination body having a housing (1) and also an illumination system which has at least one radiation source (5, 205) and also a plurality of mirrors (6, 7, 8, 15, 16; 116, 117; 206, 207, 208, 209, 216) arranged at a distance from one another, the at least one radiation source (5, 205) emitting a parallel-directed radiation and the plurality of mirrors (6, 7, 8, 15, 16; 116, 117; 206, 207, 208, 209, 216) being arranged in the beam path (9, 109) of the radiation source (5, 205), characterized in that the housing (1) has an opening (10, 210) in which there is a radiation element (11, 111, 214) which can be rotated about a vertical or horizontal axis (12), in that at least two mirrors (6, 7, 8; 206, 207, 208, 209) are arranged in a stationary manner in the housing (1) in order that the beam path emitted horizontally by the radiation source (5, 205) is deflected horizontally at least once and subsequently directed in the vertical or horizontal direction into the radiation element (11, 111, 214) and in that the radiation element (11, 111, 214) has a directional mirror (16, 116, 216) arranged at the end of the beam path in order to direct the deflected beam into the space to be illuminated.

2. Illumination body according to claim 1, characterized in that the said opening (10, 210) is provided in the bottom or covering element (3) of the housing (1) and the radiation element (11, 111, 214) in the said opening (10, 210). can be rotated about a vertical axis (12), in that a mirror (8) is arranged in a stationary manner in the housing (1) in order that the beam path emitted horizontally by the radiation source (5, 205) is directed in the vertical direction into the radiation element (11, 111, 214) and in that the radiation element (11, 111, 214) has a deflection mirror (15, 115) in order that the arriving beam path is directed into a horizontal position, or a position inclined at most by 45°, and is directed onto the directional mirror (16, 116, 216).

3. Illumination body according to claim 2, characterized in that the deflection mirror (15, 115) of the radiation element (14, 114, 214) is inclined by 45°.

4. Illumination body according to claim 1, characterized in that the directional mirror (16, 116, 216) of the radiation element (14, 114, 214) can be pivoted about a horizontal axis (17, 117), which is perpendicular to the beam path.

5. Illumination body according to claim 4, characterized in that he directional mirror (16, 116, 216) of the radiation element can be pivoted about a second axis (18, 118), which is perpendicular to the horizontal axis (17, 117).

6. Illumination body according to claim 1, characterized in that at least one converging lens, a filter and/or a focusing optical arrangement are additionally arranged in the beam path.

7. Illumination body according to claim 1, characterized in that it has a housing (2), which is square in plan, with a horizontal bottom element (3), in that at least two stationary mirrors (6, 7, 8) are arranged in the housing (2), which mirrors serve as deflection elements for the radiation and, through reflection, effect a lengthening of the beam path (9) within the housing (2), in that the radiation element (14) is fixed in a releasable manner on the housing (2) and has an essentially tubular wall.

8. Illumination body according to claim 7, characterized in that the radiation element (11) is l-shaped and has a light exit opening (14a).

9. Illumination body according to claim 7, characterized in that the radiation element (111) is t-shaped and has two light exit openings (114a).

10. Illumination body according to claim 8, the radiation element (11, 111) having a horizontal tube section (14, 114) characterized in that the horizontal tube section (14, 114) can be pivoted about a horizontal axis (19, 119).
